(19) United States
(12) Patent Application Publication
(10) Pub. No.: US 2015/0182418 A1
(43) Pub. Date: Jul. 2, 2015

(54) MASSAGE FURNITURE ITEM AND METHOD OF OPERATION

(71) Applicant: Select Comfort Corporation, Minneapolis, MN (US)

(72) Inventor: Vit Zaiss, Plymouth, MN (US)

(21) Appl. No.: 14/588,617

(22) Filed: Jan. 2, 2015

Related U.S. Application Data
(60) Provisional application No. 61/923,029, filed on Jan. 2, 2014.

(51) Int. Cl. A61H 23/02; A61H 15/00

(52) U.S. Cl. CPC A61H 23/0263; A61H 15/00

(57) ABSTRACT

A furniture item includes two massage elements that are each operated to generate a vibration that can be transmitted into the furniture item, where the vibrations create a joint vibrational wave. The frequency of each vibration can be continuously varied within a predetermined frequency range. The shifting frequencies of the massage elements cause the peaks and troughs of the wave of the vibrational wave to move across the furniture element to create the sensation of a moving vibration for a user resting on the furniture item.

### CROSS REFERENCE TO RELATED APPLICATIONS

This application claims benefit of U.S. Provisional Application Ser. No. 61/923,029 filed Jan. 2, 2014, the content of which is incorporated herein by reference in its entirety.

### TECHNICAL FIELD

This document pertains generally, but not by way of limitation, to furniture items having massage elements operable for inducing massage sensations in users resting on the furniture item. More specifically, the present disclosure pertains to furniture items having massage elements and methods of operating for inducing moving massage sensations in users resting on the furniture item.

### BACKGROUND

Furniture item such as chairs, beds, and adjustable bed foundations are often fitted with mechanical massage elements that are operated to induce a vibration in the furniture item for inducing massage sensations in a user resting on the furniture item. The mechanical massage elements typically comprise a motor for rotating an eccentrically weighted wheel or gear. The weighting of the wheel or gear causes a harmonic vibration in the motor as the wheel or gear is rotated. The harmonic vibration propagates through the motor mounts into the furniture item to induce a massage sensation in a user resting on the furniture item. The frequency of the vibration can be altered by increasing or decreasing the rotational speed of the wheel or gear so as to change the massage sensation felt by the user. However, further altering the characteristics of the vibration is limited by the simplicity of the massage elements as the only variable feature of the massage element is the rotational speed of the motor.

A similar drawback is that the massage elements are fixedly mounted to the furniture item to efficiently transmit the vibrations into the furniture item. The fixed mounting causes the vibrations to propagate through the furniture item in a defined pattern. Specifically, at a given frequency, the portions of the furniture item corresponding to the peaks and troughs of the wave will intensely vibrate while the intermittent portions will minimally vibrate. As a result, certain parts of the user's body will receive more massaging and other parts will receive less massaging requiring the user to shift their body to uniformly massage their body. In addition to requiring the user to actively shift their body, in certain situation, such as massage beds, the user may be unconscious or not capable of moving their body if the user is infirm or ill.

Accordingly, there is a need for improving the massage sensation experience by users resting on the furniture item.

### OVERVIEW

The present inventor has recognized, among other things, that a problem to be solved can include the fixed vibrating regions resulting from fixedly mounted massage elements. In an example, the present subject matter can provide a solution to this problem, such as by providing at least two massage elements fixedly mounted to the furniture item. Each massage element can be operated to generate a vibration that can be transmitted into the furniture item. Each massage element can be operated to continuously change the frequency of the vibration within a predetermined frequency range. The vibrations generated by each massage element propagate through the furniture item and interfere to create a joint vibrational wave. The shifting frequencies of the massage elements causes the peaks and troughs of the wave of the vibrational wave to move across the furniture element creating a moving massage sensation for a user resting on the furniture item allowing the user to be uniformly massaged without shifting on the furniture item.

In an example, a furniture item can include a first massage element and a second massage element mounted to the furniture item. The first and second massage element can each include an eccentrically weighted rotary element that can be rotated to induce a vibration in the massage element that propagates into the furniture element. The first rotary element of the first massage element can be cycled through a first plurality of rotational speeds at a first cyclic rate to create a first vibration in the furniture item that has a frequency, which cycles through a first plurality of frequencies with the changing rotational speeds. The second rotary element of the second massage element can be cycled through a second plurality of rotational speeds at a second cyclic rate to create a second vibration in the furniture item that has a frequency, which cycles through a second plurality of frequencies with the changing rotational speeds. The first and second vibrations combine as the vibrations propagate through the furniture item to form a joint vibration in the furniture item, wherein the changing frequencies of the first and second vibrations causes the peaks and furrows of the joint vibration to move across the furniture item.

In an example, the furniture item can comprise an adjustable bed foundation having a support surface, a head massage element and a foot massage element. The head massage element can be mounted at one end of the support surface and includes an eccentrically weighted head rotary element. The head rotary element of the head massage element can be cycled through a first plurality of rotational speeds at a first cyclic rate to create a first vibration in the furniture item that has a frequency, which cycles through a first plurality of frequencies with the changing rotational speeds. The foot rotary element of the foot massage element can be cycled through a second plurality of rotational speeds at a second cyclic rate to create a second vibration in the furniture item that has a frequency, which cycles through a second plurality of frequencies with the changing rotational speeds. The first and second vibrations combine as the vibrations propagate through the furniture item to form a joint vibration in the adjustable bed foundation, wherein the changing frequencies of the first and second vibrations causes the peaks and furrows of the joint vibration to move across the adjustable bed foundation. In certain examples, the peaks and furrows of the joint vibration move laterally and longitudinally across the adjustable bed foundation.

In an example, a method for providing moving vibrating regions in a furniture item can include the step of providing a first massage element having a first rotary element. The method can also include the step of providing a second massage element having a second rotary element. The method can also include the step of continuously cycling the rotational speed of the first rotary element through a first plurality of rotational speeds at a first cyclic rate to create a first vibration in the furniture item that has a first cycling frequency. The method can also include the step of continuously cycling the rotational speed of the second rotary element through a second plurality of rotational speeds at a second cyclic rate to create a second vibration in the furniture item that has a second cycling frequency, wherein the first and second vibrations combine to create a joint vibration having peaks and furrows moving across the furniture item.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a schematic diagram of a furniture item according to at least one example of the present disclosure.

FIG. 2 is a representative diagram of a method of operating a pair of massage elements according to at least one example of the present disclosure.

FIG. 3 is a representative diagram of a method of operating a pair of massage elements according to at least one example of the present disclosure.

FIG. 4 is a representative diagram of a method of operating a pair of massage elements according to at least one example of the present disclosure.

FIG. 5 is a schematic diagram of a furniture item having an adjustable bed frame according to at least one example of the present disclosure.

### DETAILED DESCRIPTION

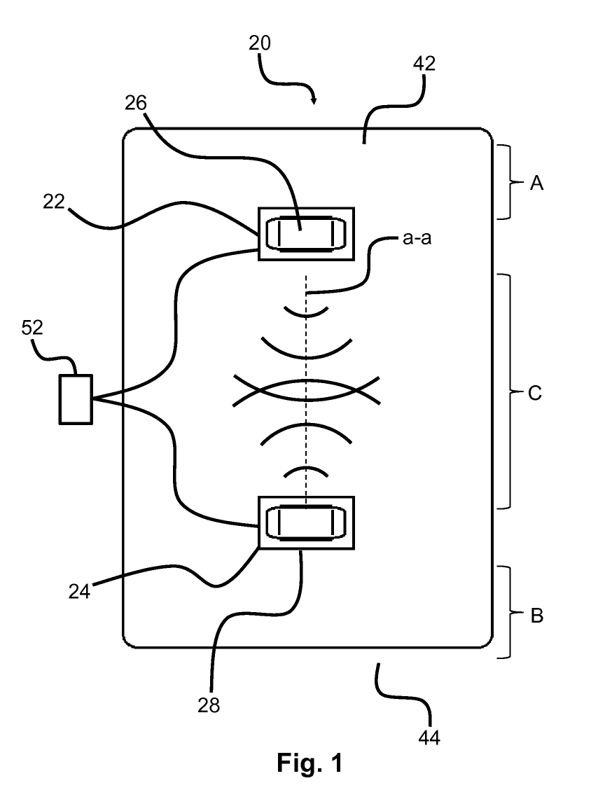

As depicted in FIG. 1, a furniture item 20, according to an example of the present subject matter, can comprise a first massage element 22 and a second massage element 24. The first massage element 22 can comprise a first rotary element 26 rotatable at a first rotational speed. The first rotary element 26 can be eccentrically weighted such that rotating the first rotary element 26 induces a first vibration in the first massage element 22 that can be transmitted through the furniture item 20. The second massage element 24 can comprise a second rotary element 28 rotatable at a second rotational speed. The second rotary element 28 can be eccentrically weighted such that rotating the second rotary element 28 induces a second vibration in the second massage element 24 that can be transmitted through the furniture item 20.

As depicted in FIG. 1, the first and second massage elements 22, 24 are aligned on the furniture item 20 on a longitudinal axis a-a extending between a first edge 42 and an opposing second edge 44. In an example, the first massage element 22 is inset from the first edge 42 along the longitudinal axis a-a at a first distance A. In certain examples, the first distance A is about 15 to 25 inches. In an example, the second massage element 24 is inset from the second edge 44 along the longitudinal axis a-a at a second distance B. In certain examples, the second distance B is about 20 to 35 inches. In an example, the first massage element 22 and the second massage element 24 are spaced apart along longitudinal axis a-a at a minimum distance C. In certain examples, the minimum distance C is about 15 to about 25 inches.

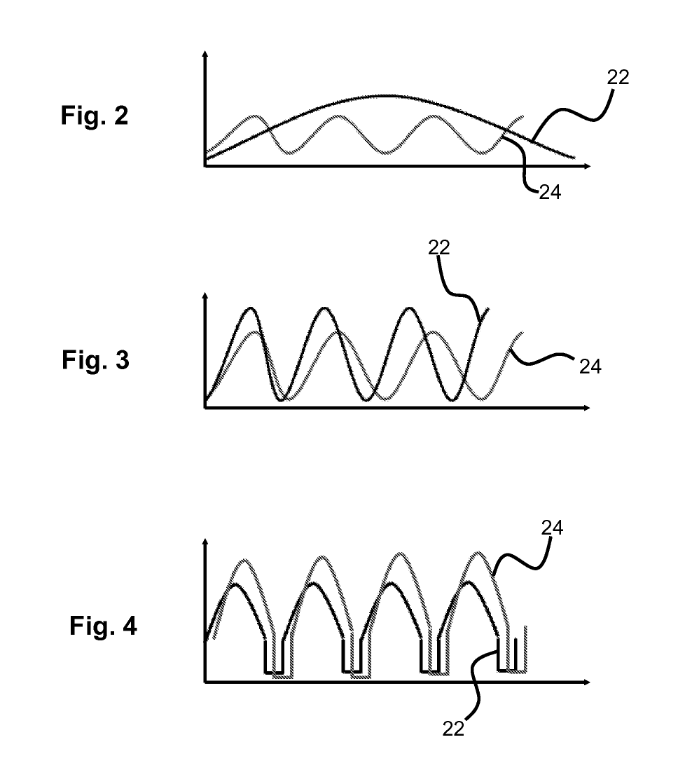

As depicted in FIGS. 2-4, the rotational speed of the first rotary element 26 can be varied within a first range of rotational speeds at a first cyclic rate. Similarly, the rotational speed of the second rotary element 28 can be continuously varied within a second range of rotational speeds at a second cyclic rate. In an example operational mode, the rotational speed of the first rotary element 26 is cycled between about 20 Hz and about 40 Hz at a cyclic rate of about 10 to 15 sec per half period. Similarly, the rotational speed of the second rotary element 28 is cycled between about 25 Hz and about 30 Hz at a cyclic rate of about 1 sec per half period. In another example operational mode, the rotational speed of the first rotary element 26 is cycled between about 20 Hz and about 40 Hz at a cyclic rate of about 2 to 4 sec per half period. Similarly, the rotational speed of the second rotary element 28 is cycled between about 20 Hz and about 30 Hz at a cyclic rate of about 2 to 4 sec per half period. In another example operational mode, the rotational speed of the first rotary element 26 is cycled between about 20 Hz and about 30 Hz at a cyclic rate of about 2 sec per half period. Similarly, the rotational speed of the second rotary element 28 is cycled between about 20 Hz and about 40 Hz at a cyclic rate of about 2 sec per half period. In this configuration, the first and second rotary elements 26, 28 are paused for about 1 second between each cycle of rotational speeds.

In an example, the furniture item 20 includes a controller 52 operably connected to the first and second massage elements 22, 24. In operation, the controller 52 is operable to change the operation of the first and second massage elements 22, 24 between preset operational modes. In certain examples, the controller 52 is operable to individually adjust the cyclic rate and/or rotational speed of the first or second massage elements 22, 24.

As depicted in FIGS. 2-4, each vibration generated by the first and second massage elements 24, 26 can have a vibrational frequency creating vibrational peaks and troughs. As the first and second vibrations propagate through the furniture item and encounter each other, the first and second vibrations can combine into a joint vibrational wave that incorporates the combined vibrational properties of the first and second vibrations through wave interference. The shifting frequencies of the first and second vibrations can have a number of effects including, but not limited to, shifting the positions on the furniture item 20 of the peaks and troughs of the joint vibrational wave. The moving peaks and troughs can create a sensation of a moving massage for users resting on the furniture item 20.

In an example, a method for providing moving vibrating regions in a furniture item 20 can include the step of providing a first massage element 22 having a first rotary element 26. The method can also include the step of providing a second massage element 24 having a second rotary element 28. The method can also include the step of continuously cycling the rotational speed of the first rotary element 26 through a first plurality of rotational speeds at a first cyclic rate to create a first vibration in the furniture item 20 that has a first cycling frequency. The method can also include the step of continuously cycling the rotational speed of the second rotary element 28 through a second plurality of rotational speeds at a second cyclic rate to create a second vibration in the furniture item 20 that has a second cycling frequency, wherein the first and second vibrations combine to create a joint vibration having peaks and furrows moving across the furniture item 20.

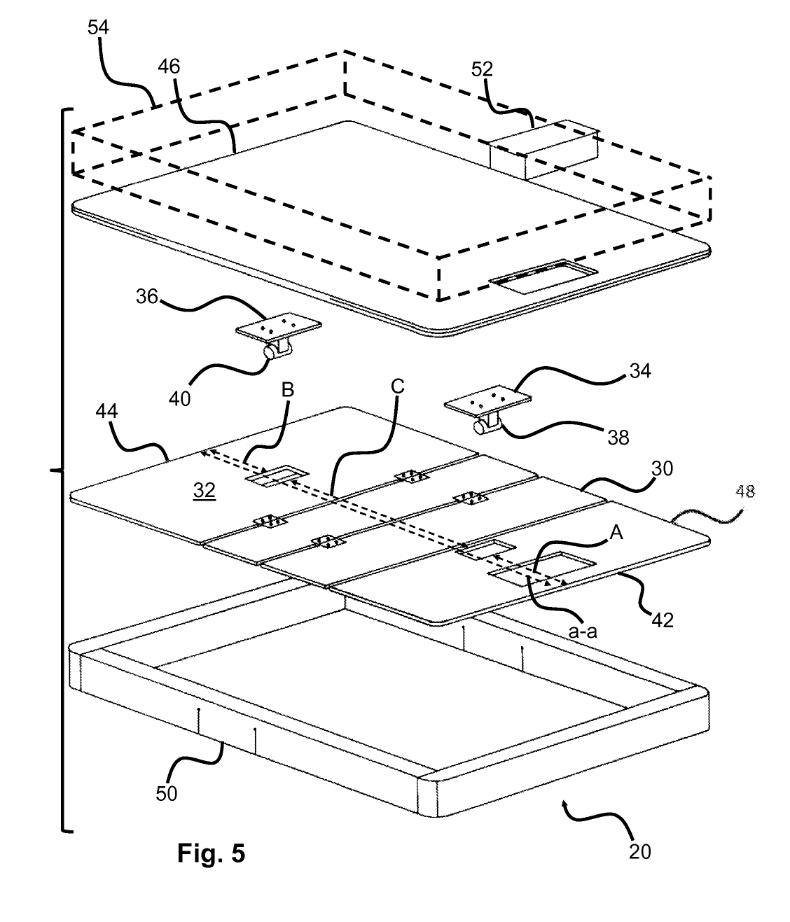

As depicted in FIG. 5, in an example, the furniture item 20 can comprise an adjustable bed foundation 30 having a support surface 32, a head massage element 34 and a foot massage element 36. In certain examples, the furniture item 20 comprises a frame 50 for receiving the adjustable bed foundation 30. The foot massage element 34 can be mounted at a foot end of the adjustable bed foundation 30 and can comprise a foot rotary element 38 rotatable at a first rotational speed. The foot rotary element 38 can be eccentrically weighted such that rotating the foot rotary element 38 induces a first vibration in the foot massage element 34 that can be transmitted through the adjustable bed foundation 30. The head massage element 36 can be mounted at the head end of the adjustable bed foundation 30 and can comprise a head rotary element 40 rotatable at a second rotational speed. The head rotary element 40 can be eccentrically weighted such that rotating the head rotary element 40 induces a second vibration in the head massage element 36 that can be transmitted through the adjustable bed foundation 30.

In an example, the furniture item 20 can include a mattress 54 which can be supported by the adjustable bed foundation 30. In some examples, the massage elements 34 and 36 can be connected to the furniture item 20 in a manner other than as illustrated so long as first and second vibrations are transmitted through the mattress 54 to a user resting on the mattress 54. For example, the massage elements 34 and 36 can be connected to the adjustable bed foundation 30 and/or the mattress 54 via a damping component.

In an example, the furniture item 20 further comprises a flexible topper 46. In this configuration, the adjustable bed foundation 30 can comprise a plurality of panels 48 that can be individually articulated. In this configuration, the flexible topper 46 prevents pinching of users resting on the adjustable bed foundation 30 during the articulation of the panels 48. The first and second vibrations can combine as the vibrations propagate through the furniture item 20 to form a joint vibration in the adjustable bed foundation 30, wherein the changing frequencies of the first and second vibrations cause the peaks and furrows of the joint vibration to move across the adjustable bed foundation 30. In certain examples, the peaks and furrows of the joint vibration move laterally and longitudinally across the adjustable bed foundation 30.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” “third,” etc., are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A furniture item for massaging a user resting on the furniture item, comprising:
a first massage element mounted to the furniture item and further including a first eccentrically weighted rotary element, wherein the first rotary element is rotatable at a first rotational speed to create a first vibration in the first massage element and propagating into the furniture item;
a second massage element mounted to the furniture item and further including a second eccentrically weighted rotary element, wherein the second rotary element is rotatable at a second rotational speed to create a second vibration in the second massage element and propagating into the furniture item; and
one or more controllers operably connected to the first and second massage elements to control rotational speed of the first and second massage elements such that the first rotational speed is continuously varied through a first range of rotational speeds to vary the frequency of the first vibration propagating through the furniture item and the second rotational speed is continuously varied through a second range of rotational speeds to vary the frequency of the second vibration propagating through the furniture item.

2. The furniture item of claim 1, wherein the first range of rotational speeds differs from the second range of rotational speeds.

3. The furniture item of claim 2, wherein the first range of rotational speeds at least partially overlaps with the second range of rotational speeds.

4. The furniture item of claim 1, wherein the first rotational speed is varied at a first cyclic rate, the second rotational speed is varied at a second cyclic rate, and the first cyclic rate differs from the second cyclic rate.

5. The furniture item of claim 4, wherein the first cyclic rate is about 10 to 15 seconds per half period and the second cyclic rate is about 1 second per half period.

6. The furniture item of claim 4, wherein the first cyclic rate is about 10 or more times greater than the second cyclic rate.

7. The furniture item of claim 1, wherein at least one of the first and second first rotary elements pauses between cycles of rotational speeds.

8. The furniture item of claim 1, wherein the one or more controllers is operable to individually adjust cyclic rate and rotational speed of at least one of the first and second massage elements to cause the first and second vibrations to create varying wave interference causing a sensation of a moving massage for users resting on the furniture item.

9. The furniture item of claim 1, wherein the first and second massage elements are fixedly mounted to the furniture item.

10. The furniture item of claim 1, wherein the furniture item comprises a massage bed having a mattress with the first and second massage elements mounted to the furniture item so as to cause the first and second vibrations to create varying wave interference causing a sensation of a moving massage for users resting on the mattress of the furniture item.

11. A massage bed for massaging a user resting on the massage bed, comprising:
an adjustable bed foundation having a head end and a foot end, the adjustable bed foundation supporting a mattress;
a head massage element mounted to the massage bed proximate the head end and further including an eccentrically weighted head rotary element, wherein the eccentrically weighted head rotary element is rotatable at a first rotational speed to create a first vibration in the head massage element and propagating into the bed foundation; and
a foot massage element mounted to the massage bed proximate the foot end and further including an eccentrically weighted foot rotary element, wherein the eccentrically weighted foot rotary element is rotatable at a second rotational speed to create a second vibration in the second massage element and propagating into the bed foundation; and
one or more controllers operably connected to the head and foot massage elements to control rotational speed of the head and foot massage elements such that the first rotational speed is continuously varied through a first range of rotational speeds to vary the frequency of the first vibration propagating through the bed foundation and the second rotational speed is continuously varied through a second range of rotational speeds to vary the frequency of the second vibration propagating through the bed foundation.

12. The massage bed of claim 11, wherein the first range of rotational speeds differs from the second range of rotational speeds.

13. The massage bed of claim 12, wherein the first range of rotational speeds at least partially overlaps with the second range of rotational speeds.

14. The massage bed of claim 11, wherein the first rotational speed is varied at a first cyclic rate, the second rotational speed is varied at a second cyclic rate, and the first cyclic rate differs from the second cyclic rate.

15. The massage bed of claim 11, wherein at least one of the eccentrically weighted head rotary element and eccentrically weighted foot rotary element pauses between cycles of rotational speeds.

16. The massage bed of claim 11, wherein the one or more controllers is operable to individually adjust cyclic rate and rotational speed of at least one of the head and foot massage elements to cause the first and second vibrations to create varying wave interference causing a sensation of a moving massage for users resting on the massage bed.

17. A method of providing moving massage sensations for a user resting on a furniture item, comprising the steps of:
rotating an eccentrically weighted first rotary element of a first massage element of the furniture item at a first rotational speed to create a first vibration in the first massage element that propagates into the furniture item;
rotating an eccentrically weighted second rotary element of a second massage element of the furniture item at a second rotational speed to create a second vibration in the second massage element that propagates into the furniture item; and
cycling the eccentrically weighted first rotary element through a first range of rotational speeds to vary the frequency of the first vibration.

18. The method of claim 17, and further comprising:
cycling the eccentrically weighted second rotary element through a second range of rotational speeds to vary the frequency of the second vibration.

19. The method of claim 17, wherein the first and second vibrations combine to create a joint vibration having peaks and furrows moving across a mattress of the furniture item.

20. The method of claim 17, and further comprising:
adjusting cyclic rate or rotational speed of at least one of the first and second massage elements to cause the first and second vibrations to create varying wave interference causing a sensation of a moving massage for users resting on a mattress of the furniture item.
